(19) United States
(12) Patent Application Publication
(10) Pub. No.: US 2007/0283132 A1
(43) Pub. Date: Dec. 6, 2007

(54) END-OF-BLOCK MARKERS SPANNING MULTIPLE BLOCKS FOR USE IN VIDEO CODING

(75) Inventors: Justin Ridge, Sachse, TX (US); Marta Karczewicz, San Diego, CA (US); Xianglin Wang, Santa Clara, CA (US)

Correspondence Address: FOLEY & LARDNER LLP, P.O. BOX 80278, SAN DIEGO, CA, 92138-0278, US

(73) Assignee: Nokia Corporation

(21) Appl. No.: 11/696,662

(22) Filed: Apr. 4, 2007

Related U.S. Application Data
(60) Provisional application No. 60/789,793, filed on Apr. 6, 2006.

(51) Int. Cl. G06F 9/30

(52) U.S. Cl. 712/210

(57) ABSTRACT

The present invention involves the use of the FRExt approach for FGS. According to the present invention, an 8×8 data block is de-interleaved and processed as individual 4×4 data blocks, with an additional end-of-8×8-block (EO8B) marker indicating that no more coefficients remain in any of the de-interleaved 4×4 data blocks. The EO8B symbol may be a binary flag. The invention also uses a longer codeword for the EO8B symbol, conveying information about which de-interleaved blocks contain additional coefficients.

### CROSS-REFERENCE TO RELATED PATENT APPLICATIONS

This application claims priority from Provisional Application U.S. Application 60/789,793, filed Apr. 6, 2006, incorporated herein by reference in its entirety.

### FIELD OF THE INVENTION

The present invention relates to video encoding and decoding. More particularly, the present invention relates to scalable video encoding and decoding.

### BACKGROUND OF THE INVENTION

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

Video coding standards include ITU-T H.261, ISO/IEC MPEG-1 Visual, ITU-T H.262 or ISO/IEC MPEG-2 Visual, ITU-T H.263, ISO/IEC MPEG-4 Visual and ITU-T H.264 (also know as ISO/IEC MPEG-4 AVC). In addition, there are currently efforts underway with regards to the development of new video coding standards. One such standard under development is the scalable video coding (SVC) standard, which will become the scalable extension to the H.264/AVC standard. Another such effort involves the development of China video coding standards.

SVC can provide scalable video bitstreams. A portion of a scalable video bitstream can be extracted and decoded with a degraded playback visual quality. A scalable video bitstream contains a non-scalable base layer and one or more enhancement layers. An enhancement layer may enhance the temporal resolution (i.e. the frame rate), the spatial resolution, or simply the quality of the video content represented by the lower layer or part thereof. In some cases, data of an enhancement layer can be truncated after a certain location, even at arbitrary positions, and each truncation position can include some additional data representing increasingly enhanced visual quality. Such scalability is referred to as fine-grained (granularity) scalability (FGS). In contrast to FGS, the scalability provided by a quality enhancement layer that does not provide fined-grained scalability is referred as coarse-grained scalability (CGS). An FGS layer may be designated as the base layer relative to which further FGS layers are coded

In draft Annex F of the H.264/AVC standard relating to scalable video coding, 8×8 blocks may exist in the FGS (fine-grained scalability) layer. However, it has recently been proposed that the significance map be coded using individual flags.

In H.264/AVC Fidelity Range Extensions (FRExt) which support higher-fidelity video coding by supporting increased sample accuracy and higher-resolution color information, an 8×8 block of coefficients is de-interleaved into four 4×4 blocks. This de-interleaving is represented in FIG. 1. The context adaptive variable length coding (CAVLC) encoding or decoding of each 4×4 block proceeds independent from each other. This simplifies the decoding process and obviates the need for a specific 8×8 CAVLC algorithm.

In FGS, the probability of an end-of-block (EOB) marker occurring in an individual 4×4 block may be very high. However, if decoded individually using CAVLC, at least one bit is required to indicate the EOB. This means that probabilities other than 50% cannot be modeled accurately in the variable length code (VLC) probability distribution. Currently, the 8×8 significance map in FGS is coded using individual flags, which offers very poor coding efficiency.

### SUMMARY OF THE INVENTION

The present invention uses the FRExt approach for FGS, whereby an 8×8 block is de-interleaved and processed as individual 4×4 blocks, with an additional end-of-8×8-block (EO8B) marker indicating that no more coefficients remain in any of the de-interleaved 4×4 blocks. The EO8B symbol may be a binary flag. The present invention also uses a longer codeword for the EO8B symbol, conveying information about which de-interleaved blocks contain additional coefficients. With the present invention, the coding methods used for 4×4 blocks can be re-applied to 8×8 blocks, simplifying implementation.

The present invention can be implemented directly in software using any common programming language, e.g. C/C++or assembly language. The present invention can also be implemented in hardware and used in a wide variety of consumer devices.

These and other advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a depiction of an 8×8 block of coefficients being de-interleaved into four 4×4 blocks;

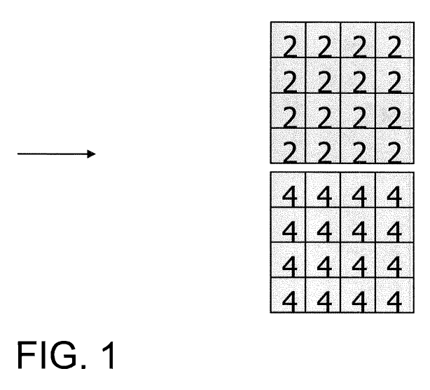

FIG. 2 shows a generic multimedia communications system for use with the present invention;

FIG. 3 is a perspective view of a mobile telephone that can be used in the implementation of the present invention; and

FIG. 4 is a schematic representation of the telephone circuitry of the mobile telephone of FIG. 3.

### DETAILED DESCRIPTION OF THE PREFERRED EMBODIMENTS

The present invention uses the FRExt approach for FGS, whereby an 8×8 block is de-interleaved and processed as individual 4×4 blocks, with an additional end-of-8×8-block (EO8B) marker indicating that no more coefficients remain in any of the de-interleaved 4×4 blocks. The EO8B symbol may be a binary flag. The present invention also uses a longer codeword for the EO8B symbol, conveying information about which de-interleaved blocks contain additional coefficients.

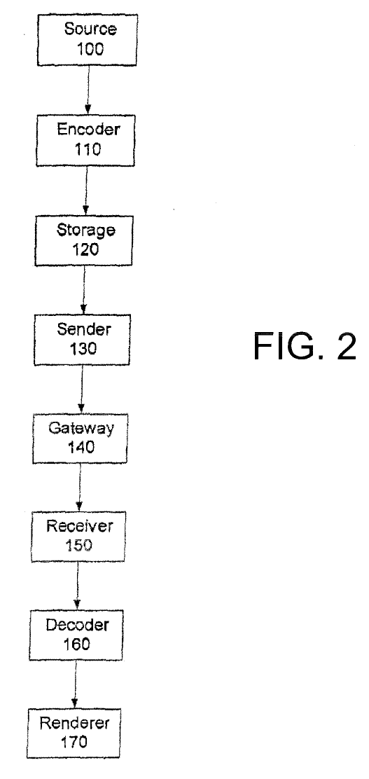

FIG. 2 shows a generic multimedia communications system for use with the present invention. As shown in FIG. 2, a data source 100 provides a source signal in an analog, uncompressed digital, or compressed digital format, or any combination of these formats. An encoder 110 encodes the source signal into a coded media bitstream. The encoder 110 may be capable of encoding more than one media type, such as audio and video, or more than one encoder 110 may be required to code different media types of the source signal. The encoder 110 may also get synthetically produced input, such as graphics and text, or it may be capable of producing coded bitstreams of synthetic media. In the following, only processing of one coded media bitstream of one media type is considered to simplify the description. It should be noted, however, that typically real-time broadcast services comprise several streams (typically at least one audio, video and text sub-titling stream). It should also be noted that the system may include many encoders, but in the following only one encoder 110 is considered to simplify the description without a lack of generality.

The coded media bitstream is transferred to a storage 120. The storage 120 may comprise any type of mass memory to store the coded media bitstream. The format of the coded media bitstream in the storage 120 may be an elementary self-contained bitstream format, or one or more coded media bitstreams may be encapsulated into a container file. Some systems operate “live”, i.e. omit storage and transfer coded media bitstream from the encoder 110 directly to the sender 130. The coded media bitstream is then transferred to the sender 130, also referred to as the server, on a need basis. The format used in the transmission may be an elementary self-contained bitstream format, a packet stream format, or one or more coded media bitstreams may be encapsulated into a container file. The encoder 110, the storage 120, and the sender 130 may reside in the same physical device or they may be included in separate devices. The encoder 110 and sender 130 may operate with live real-time content, in which case the coded media bitstream is typically not stored permanently, but rather buffered for small periods of time in the content encoder 110 and/or in the sender 130 to smooth out variations in processing delay, transfer delay, and coded media bitrate.

The sender 130 sends the coded media bitstream using a communication protocol stack. The stack may include but is not limited to Real-Time Transport Protocol (RTP), User Datagram Protocol (UDP), and Internet Protocol (IP). When the communication protocol stack is packet-oriented, the sender 130 encapsulates the coded media bitstream into packets. For example, when RTP is used, the sender 130 encapsulates the coded media bitstream into RTP packets according to an RTP payload format. Typically, each media type has a dedicated RTP payload format. It should be again noted that a system may contain more than one sender 130, but for the sake of simplicity, the following description only considers one sender 130.

The sender 130 may or may not be connected to a gateway 140 through a communication network. The gateway 140 may perform different types of functions, such as translation of a packet stream according to one communication protocol stack to another communication protocol stack, merging and forking of data streams, and manipulation of data stream according to the downlink and/or receiver capabilities, such as controlling the bit rate of the forwarded stream according to prevailing downlink network conditions. Examples of gateways 140 include multipoint conference control units (MCUs), gateways between circuit-switched and packet-switched video telephony, Push-to-talk over Cellular (PoC) servers, IP encapsulators in digital video broadcasting-handheld (DVB-H) systems, or set-top boxes that forward broadcast transmissions locally to home wireless networks. When RTP is used, the gateway 140 is called an RTP mixer and acts as an endpoint of an RTP connection.

The system includes one or more receivers 150, typically capable of receiving, de-modulating, and de-capsulating the transmitted signal into a coded media bitstream. The codec media bitstream is typically processed further by a decoder 160, whose output is one or more uncompressed media streams. Finally, a renderer 170 may reproduce the uncompressed media streams with a loudspeaker or a display, for example. The receiver 150, decoder 160, and renderer 170 may reside in the same physical device or they may be included in separate devices. It should therefore be understood that a bitstream to be decoded can be received from a remote device located within virtually any type of network, as well as from other local hardware or software. It should be also understood that, although text and examples contained herein may specifically describe an encoding process, one skilled in the art would readily understand that the same concepts and principles also apply to the corresponding decoding process and vice versa.

Scalability in terms of bitrate, decoding complexity, and picture size is a desirable property for heterogeneous and error prone environments. This property is desirable in order to counter limitations such as constraints on bit rate, display resolution, network throughput, and computational power in a receiving device.

Communication devices of the present invention may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device may communicate using various media including, but not limited to, radio, infrared, laser, cable connection, and the like.

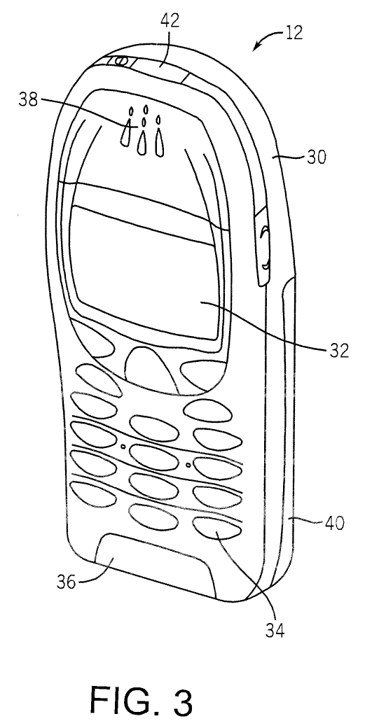

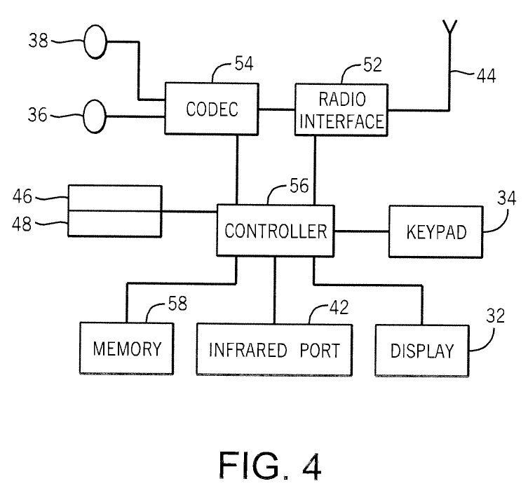

FIGS. 3 and 4 show one representative mobile telephone 12 within which the present invention may be implemented. It should be understood, however, that the present invention is not intended to be limited to one particular type of mobile telephone 12 or other electronic device. Some or all of the features depicted in FIGS. 3 and 4 could be incorporated into any or all of the devices represented in FIG. 2.

The mobile telephone 12 of FIGS. 3 and 4 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment of the invention, a card reader 48, radio interface circuitry 52, codec circuitry 54, a controller 56 and a memory 58. Individual circuits and elements are all of a type well known in the art, for example in the Nokia range of mobile telephones.

The implementation of various embodiments of the present invention is generally as follows. Given an 8×8 scan index (i.e. an index of a first coefficient in an 8×8 block to be processed), the FRExt approach of processing every fourth coefficient can be used for FGS. Thus, the pseudocode for checking the EOB is as follows:

```
for each 4x4 block in an 8x8 block {
  Bool bIsEob = true;
  for( ui8x8Index = uiStart8x8ScanIndex; ui8x8Index < 64;
  ui8x8Index+=4 )
    if( coeff[zigzag [ui8x8Index] ] != 0 )
      bIsEob = false;
  Encode EOB flag
  if (!bIsEob)
    PROCESS NEXT COEFFICIENT(S) IN DE-INTERLEAVED
    BLOCK
}
```

Therefore, in a given subband, and assuming an EOB has not already been indicated in a previous subband, four EOB markers will be sent—one for each de-interleaved 4×4 block.

However and as indicated earlier, using a one bit flag means that coding efficiency for the EOB marker becomes worse the as the distance between the probability of it being equal to zero and it being equal to 50% increases. In FGS, the probability of an EOB occurring may be around 80%, meaning this inefficiency has a substantial impact on overall performance. To overcome this deficiency, an additional marker indicating the end of all de-interleaved blocks is additionally sent. With this marker, the pseudocode becomes:

```
Bool bIs8Eob = true;
for( ui8x8Index = uiStart8x8ScanIndex; ui8x8Index < 64; ui8x8Index++ )
  if( coeff[zigzag [ui8x8Index] ] != 0 )
    bIs8Eob = false;
Encode EO8B flag
if (!bIs8Eob)
  for each 4x4 block in an 8x8 block {
    Bool bIsEob = true;
    for( ui8x8Index = uiStart8x8ScanIndex; ui8x8Index < 64;
    ui8x8Index+=4 )
    if( coeff[zigzag [ui8x8Index] ] != 0 )
      bIsEob = false;
    Encode EOB flag
    if (!bIsEob)
      PROCESS NEXT COEFFICIENT(S) IN DE-INTERLEAVED
      BLOCK
  }
```

It should be noted that two EOB checks are performed, but the first check differs in nature from the second check. In the first EOB check, every coefficient, and not every fourth coefficient, is scanned. The probability of the entire 8×8 block containing no more coefficients is generally closer to 50%, and therefore the use of a one-bit flag results in an improved coding efficiency performance.

In general, the encoding process has been discussed above. In the decoder, the EO8B flag would be read from the bitstream and, if set to 1, all remaining coefficients in the 8×8 block would be marked as decoded.

In a further embodiment of the present invention, an EO8B bit that is set to 1 may be followed by an additional two bits indicating which out of two pairs of 4×4 blocks the EOB applies to. Thus the EOB becomes hierarchical, similar to the approach used for the coded block pattern/coded block flag (CBP/CBF). In a further embodiment, the first EO8B is skipped, so that only the additional two bits are sent indicating which out of two pairs of 4×4 blocks contain further coefficients. In yet another embodiment, the EOB values for each of the de-interleaved 4×4 blocks may be grouped to form a single VLC codeword. In this case, the second EOB check, that is performed for each de-interleaved 4×4 block, becomes unnecessary. According to this scenario, the VLC codebook that is used to encode the set of EOB flags may be known in advance to both the encoder and the decoder, it may be signaled explicitly in the bitstream, a VLC may be selected from among a set of possible VLCs by coding the index of the VLC table itself to/from the bit stream, or it may be adapted automatically based upon previously decoded information. Furthermore, the number of 4×4 blocks grouped to form the single EOB marker may be signaled in the bit stream, or determined dynamically based on previously decoded information such as the EOB value or non-zero coefficient positions in neighboring blocks.

The present invention is described in the general context of method steps, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule based logic and other logic to accomplish the various database searching steps, correlation steps, comparison steps and decision steps. It should also be noted that the words “component” and “module,” as used herein and in the claims, is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A method of decoding scalable video data with fine grain scalability from a bit stream, comprising:
decoding data from the bit stream; and
decoding a single indication from the bit stream, the single indication indicating an end-of-block for each of multiple 4×4 data blocks that are decoded.

2. The method of claim 1, wherein the data comprises an 8×8 data block interleaved from the multiple 4×4 data blocks.

3. The method of claim 1, wherein the single indication comprises a single flag, the single flag indicating that no additional non-zero coefficients remain in any of the multiple 4×4 data blocks.

4. The method of claim 1, wherein the single indication comprises a variable length code codeword, the variable length codeword indicating which subsets of blocks from the multiple 4×4 data blocks contain no additional non-zero coefficients.

5. A computer program for decoding scalable video data with fine grain scalability from a bit stream, comprising:
computer code for decoding data from the bit stream; and
computer code for decoding a single indication from the bit stream, the single indication indicating an end-of-block for each of multiple 4×4 data blocks that are decoded.

6. The computer program product of claim 5, wherein the data comprises an 8×8 data block of data interleaved from the multiple 4×4 data blocks.

7. The computer program product of claim 5, wherein the single indication comprises a single flag, the single flag indicating that no additional non-zero coefficients remain in any of the multiple 4×4 data blocks.

8. The computer program product of claim 5, wherein the single indication comprises a variable length code codeword, the variable length codeword indicating which subsets of blocks from the multiple 4×4 data blocks contain no additional non-zero coefficients.

9. An decoding device, comprising:
a processor; and
a memory unit communicatively connected to the processor and including a computer program for decoding scalable video data with fine grain scalability from a bit stream, comprising:
computer code for decoding data from the bit stream; and
computer code for decoding a single indication from the bit stream, the single indication indicating an end-of-block for each of multiple 4×4 data blocks that are decoded.

10. The decoding device of claim 9, wherein the data comprises an 8×8 data block of data interleaved from the multiple 4×4 data blocks.

11. The decoding device of claim 9, wherein the single indication comprises a single flag, the single flag indicating that no additional non-zero coefficients remain in any of the multiple 4×4 data blocks.

12. The decoding device of claim 9, wherein the single indication comprises a variable length code codeword, the variable length codeword indicating which subsets of blocks from the multiple 4×4 data blocks contain no additional non-zero coefficients.

13. A method of encoding scalable video data with fine grain scalability from a bit stream wherein video data in a fine grain scalability layer includes 8×8 blocks of data, the method comprising:
encoding data into the bit stream by de-interleaving and processing the 8×8 blocks of data as individual 4×4 blocks of data;
determining when there are no non-zero coefficients in any remaining 4×4 blocks of data; and
when it is determined there are no non-zero coefficients remaining, encoding a single indication into the bit stream, the single indication indicating an end-of-block for each of multiple 4×4 data blocks that are encoded.

14. The method of claim 13, wherein the multiple 4×4 data blocks are de-interleaved from an 8×8 data block.

15. The method of claim 13, wherein the single indication comprises a single flag, the single flag indicating that no additional non-zero coefficients remain in any of the multiple 4×4 data blocks.

16. The method of claim 13, wherein the single indication comprises a variable length code codeword, the variable length codeword indicating which subsets of blocks from the multiple 4×4 data blocks contain no additional non-zero coefficients.

17. A computer program product for encoding scalable video data with fine grain scalability from a bit stream, comprising:
computer code for encoding data into the bit stream; and
computer code for encoding a single indication into the bit stream, the single indication indicating an end-of-block for each of multiple 4×4 data blocks that are encoded.

18. The computer program product of claim 17, wherein the multiple 4×4 data blocks are de-interleaved from an 8×8 data block.

19. The computer program product of claim 17, wherein the single indication comprises a single flag, the single flag indicating that no additional non-zero coefficients remain in any of the multiple 4×4 data blocks.

20. The computer program product of claim 17, wherein the single indication comprises a variable length code codeword, the variable length codeword indicating which subsets of blocks from the multiple 4×4 data blocks contain no additional non-zero coefficients.

21. An encoding device, comprising:
a processor; and
a memory unit communicatively connected to the processor and including a computer program product for encoding scalable video data with fine grain scalability comprising:
computer code for encoding data into a bit stream; and
computer code for encoding a single indication into the bit stream, the single indication indicating an end-of-block for each of multiple 4×4 data blocks that are encoded.

22. The decoding device of claim 21, wherein the multiple 4×4 data blocks are de-interleaved from an 8×8 data block.

23. The decoding device of claim 21, wherein the single indication comprises a single flag, the single flag indicating that no additional non-zero coefficients remain in any of the multiple 4×4 data blocks.

24. The decoding device of claim 21, wherein the single indication comprises a variable length code codeword, the variable length codeword indicating which subsets of blocks from the multiple 4×4 data blocks contain no additional non-zero coefficients.
